(19) United States
(12) Patent Application Publication
(10) Pub. No.: US 2024/0282214 A1
(43) Pub. Date: Aug. 22, 2024

(54) SYSTEM FOR CATEGORIZING ITEMS ARISING FROM AUTOMATED ITEM GENERATION

(71) Applicant: MGHL Partners Inc., Edmonton (CA)

(72) Inventors: Mark Gierl, Edmonton (CA); Hollis Lai, Edmonton (CA); Vasily Tanygin, Edmonton (CA); Donna Matovinovic, Edmonton (CA)

(21) Appl. No.: 18/113,026

(22) Filed: Feb. 22, 2023

Related U.S. Application Data
(60) Provisional application No. 63/314,133, filed on Feb. 25, 2022.

(51) Int. Cl. G09B 7/06

(52) U.S. Cl. CPC G09B 7/06

(57) ABSTRACT

The present invention provides for a system for searching, requesting and dispensing automated item generation test items generated from a test model wherein metadata or content coding associated with elements of the test item or the test model are capable of being used as logical conditions for display of the models or generation of test items.

### FIELD OF THE INVENTION

The present invention pertains to the field of computer-generated assessments.

### BACKGROUND

All of the publications, patents and patent applications cited within this application are herein incorporated by reference in their entirety to the same extent as if the disclosure of each individual publication, patent application or patent was specifically and individually indicated to be incorporated by reference in its entirety.

Testing organizations require large numbers of high-quality items to support innovations in test delivery and test design. Computer-based testing (CBT) ahs replaced traditional paper-based testing because the time, effort, and expense required to print, score, and report paper-based tests are prohibitive. CBT is a more efficient and economical method for administrating tests, providing organizations with a range of new and desirable test administration options as well as providing examinees the opportunity to receive instant feedback allowing the assessment to serve both formative and summative purposes.

Test design provides a further source of innovation for testing organizations, allowing them to create assessment products that can be used to satisfy different purposes. For instance, CBTs can be designed to identify examinee's cognitive-problem solving strengths and weaknesses, or they can be designed to engage examinees in conversational dialogues thereby measuring speaking skills. In short, innovations in test delivery and test design allow organizations to offer a wide range of new and innovative products and services. But this expanded list of products and services also requires more testing; and to address this need, large repositories of test questions (items) are needed, known in the art as a “bank”. These banks must be created and then frequently replenished to ensure that examinees receive a continuous supply of unique, content-specific, items while limiting exposure to maintain test security. There is therefore a need for large numbers of test items to be available, or capable of being prepared, to maintain adequate supply in the banks.

One method that may be used to create the numbers of test items needed for CBT, is by way of automatic item generation (AIG), where cognitive theory and psychometric practice guide the production of items that are created with the aid of computer technology. AIG can be used to produce large numbers of items from a single item model and therefore may serve as a method that can be used to scale the test item development process.

The prior art describes a three-step approach to AIG. In step 1, the content for item generation is identified, for example a Subject Matter Expert (SME) identifies and structures the content required to generate new test items. One framework that can be used to organize and structure the content is known in the art as a cognitive model for AIG, which highlights the knowledge and skills required to solve a problem in a specific content area. This model also organizes the cognitive- and content-specific information, thereby presenting a structured representation of how the SME expect examinees will think about and solve problems in a specific content area.

In step 2, an item model is developed to specify where the content from the cognitive model must be placed to generate new items. The item model identifies which parts of the test item can be manipulated for generation. For a selected response item type, it includes the stem, the options (itself containing variables and values), and the auxiliary information. Variables include values that will be manipulated during item generation, and the stem contains the content or question the examinee is required to answer. The options include a set of alternative answers with one correct option and one or more incorrect options. Auxiliary information includes any supplementary material, such as graphs, tables, figures, or multimedia exhibits that augment the content presented in the stem and/or options.

In step 3, computer-based algorithms place the cognitive model content specified in step 1 into the item model developed in step 2. Assembly is conducted with a computer algorithm because it is often a complex combinatorial task, with logical constraints providing one straight-forward approach for generating items when item modelling is used. The generation process can be described as an iterator that permutes through all combinations of values and, in the process, eliminates combinations that do not meet the logical constraints defined by the SME in the cognitive model.

In this manner, large numbers of test items can be generated by reference to computer-based algorithms constrained by the item model; the item model informed by the cognitive model and SME input. Yet with an abundance of content, the next challenge becomes organizing and administering the creation of, and items within, the bank. The management of a bank requires that items be appended with information so they can be identified and differentiated. Once differentiated, the items can be used to address a specific purpose or to achieve a particular goal within a testing organization.

To create a digital assessment with a flexible and frequent administration schedule that serves multiple purposes, thousands of items are needed, which can easily be created using AIG. However, to accommodate this volume, two management challenges must be overcome because a much larger number of items needs to be organized and managed. The first challenge stems from the sheer volume of items produced using AIG; which for banks containing millions of items problems related to storage limits, search criteria, and content review quickly arise. The second management challenge occurs when shifting the unit of analysis from the item to the model. Testing organizations are familiar with developing and organizing items, but AIG creates another new challenge that many organizations have not likely experienced, because the generating models must also be created, organized, and managed. While traditional development relies on processes where items are written, reviewed, and revised individually, AIG uses processes where models are written, reviewed, and revised in order to generate items. Hence, testing organizations must manage the generating models in addition to the generated items in their bank.

Therefore, the art is in need of a novel way to categorize, generate, manage and access item banks as well as the item models used to generate the items within said banks.

### SUMMARY OF THE INVENTION

The present invention provides for a system for searching, requesting and dispensing computer generated test items generated from a test model comprising a computing device configured to communicate with a user, the computing device comprising a processor and a graphical user interface; a computer readable memory with computer executable instructions embedded thereon, the computer executable instructions configured to cause the processor to: display on said graphical user interface an identifier correlating with those test models containing content coding selected by said user; display on said graphical user interface the number of items that may be generated by each test model containing content coding selected by said user; receive a request from said user to generate test items from at least one of said test model containing content coding selected by said user; display on said graphical user interface an identifier correlating with generated test items; display on said graphical user interface generated test items selected for display by said user; and communicate those generated test items selected by said user to a system of said user's choice; and wherein test models containing metadata is a data structure comprising an item generation model and at least one item of metadata associated with said item generation model. In one aspect the system of said user's choice is a QTI compliant data exchange. In another aspect the data structure further comprises at least one variable within said item model having an item of content coding associated with it. In a further aspect, the request from said user to generate test items from at least one of said test model containing content coding includes constraints on the test items to be generated selected from the group comprising additional content coding values, a maximum number of test items to be generated, and communication instructions for said generated test items. In a still further aspect the data structure further comprises a list of all previously generated items from the item generation model. In a still further aspect said request from said user to generate test items from at least one of said test model containing content coding includes constraints on the test items to be generated selected from the group comprising additional content coding values, a maximum number of test items to be generated, and communication instructions for said generated test items.

### BRIEF DESCRIPTION OF THE FIGURES

FIG. 1 shows an exemplary item model useful for automated item generation;

FIG. 2 shows exemplary items capable of generation from the exemplary item model presented in FIG. 1;

FIG. 3 shows a single exemplary item, with content coding applied to data elements within the item;

FIG. 4 shows an exemplary item; and

FIG. 5 shows an example of metadata and content coding applied to the exemplary item shown in FIG. 4.

### DETAILED DESCRIPTION OF THE PRESENT INVENTION

To address the challenges arising from increasing numbers of test items forming banks in the testing industry, a shift in banking management is required. With the traditional approach for test item management, items within a bank are managed at the item level; yet this is not as useful for those item banks generated by way of AIG, as those items are predominantly managed at the model level.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, “item generation model” means a model for generation of test items in a question, known in the art as an “n-layer model”, intended to be used as part of an Automated Item Generation system, and as more fully described by U.S. Patent Publication No. 2014/0214386 by Gierl, et al; the contents of which are incorporated by reference, in their entirety. It is contemplated that an item generation model contains at least one element, each element capable of being varied simultaneously to produce different items, with an element capable of presenting different information within a test item, being referred to as a variable.

As used herein a “test item” or an “item” within an item generation model, is a task provided to a test taker as part of an assessment process. A question followed by a series of potential answers and to which the test taker is asked to select the correct answer, commonly known in the art as a “multiple choice question”, is a non-limiting example of a test item. Test items are not explicitly limited, to multiple choice questions,

[symbol]

As used herein, “metadata” refers to descriptive data about data of any type; and includes data that may describe a single datum or entire collections of similar data. Metadata provides context for data and additional information to the user and may associate one piece of data with another piece of data based on properties shared in common. As used herein, metadata includes, but is not limited to, the name or identifier of the individual creating the data, date of creation of the data, last date of information objects and other descriptors relating to the data.

As used herein “content coding” refers to a form of metadata wherein the metadata element describes the relation of the data element it is associated with to a taxonomy or hierarchy where the data elements are given additional meaning because of their position and relationship with other metadata data elements.

As used herein, the terms “processor and “central processing unit’ or “CPU” are used interchangeably and refer to a device that is able to read a program from a computer memory (e.g., ROM or other computer memory) and per form a set of steps according to the program.

As used herein, the terms “computer memory” refer to any storage medium readable by a computer processor. Examples of computer memory include, but are not limited to, RAM, ROM, computer chips, digital video discs (DVD), compact discs (CDs), hard disk drives (HDD), and magnetic tape.

As used herein, the term “computer readable medium” refers to any device or system for storing and providing information (e.g., data and instructions) to a computer processor. Examples of computer readable media include, but are not limited to, DVDs, CDs, hard disk drives, magnetic tape and servers for streaming media over networks. In various embodiments, aspects of the present invention including data structures and methods may be stored on a computer readable medium.

As used herein, the term “XML” refers to Extensible Markup Language through which information providers can define new tag and attribute names at will. As known in the art software modules, referred to as XML processors, are used to read XML documents and provide access to their content and structure.

As used herein a graphical user interface refers to an interface through which a user may interact with a computer by way of displayed graphic icons to the user. This interaction may be further enhanced through devices capable of receiving user input, and providing same to the computer, with the inputs generating altered display of icons to the user.

Embodiments of the present invention are directed towards a method and system for the generation of model items incorporating metadata. Embodiments of the present invention are also directed to a system for generation of model items only incorporating pre-selected metadata or content coding. In some embodiments the present invention may be used as part of a computerized system to generate test items with, or without, disclosed metadata or content coding relating to the elements forming the generated test item. In some embodiments the present invention may be used as part of a computerized system to generate test items without disclosed metadata or content coding, but all items generated contain one or all elements which contained pre-selected metadata or content coding.

The present invention also provides for a system for presenting to a user test models which contain metadata or content coding meeting certain criteria established by the user.

Model management is accomplished with the use of content coding, a method used to describe data elements which form part of the item, where descriptive data about each data element within the item, or the item itself, can be defined at many levels of specificity ranging from specific to general. By way of non-limiting example, the format of the item can be described; where formats include multiple choice, numeric response, written response, passage based, and multimedia based. By way of non-limiting example, the purpose for the item can be described, or the learning objectives and blueprint categories. By way of non-limiting example, other item development attributes can be described, such may include year the item was written, SME name, SME demographics, development status, and review status. By way of non-limiting example, statistical characteristics for the item can be described, which include, but are not limited to, readability indices, classical item statistics, and item response theory parameters.

As described herein, the type of descriptive data that may be used in an AIG item can include conventional labels at the item level such as format, purpose, item development attributes, and statistical characteristics. But additional information in the form of “content codes” can also be produced; wherein the content codes are created for different data elements (i.e., parts of the item model). This information is then appended to every item during the generation process thereby rendering each item as unique because every item has a unique set of content codes.

Content codes can be created using two different methods. The first method is based on an ad hoc review of the model and/or the item where an SME decides on the content descriptors. This method does not require any advanced planning and therefore is quite flexible. The disadvantage of ad hoc coding is that the content definitions may be overly broad, subject to change and, challenging to interpret. Ad hoc coding is particularly problematic when different SME are responsible for creating the codes, as variation in content identification and therefore content coding is possible. For example, a medical SME could describe the common cold as Nasopharyngitis, Rhinopharyngitis, or Acute Coryza. When different content codes are used to describe the same data element, searching for generated items with these codes is challenging, particularly as more item models are created to measure; in this example, respiratory illness because the conditions are not specific and the content codes that differentiate each medical condition are not defined which means that different search terms can yield different sets of generated items. Appending content codes to each generated item can also be a tedious and time-consuming task, especially when large numbers of items are created. SMEs must review the item, decide on the content codes, and then map the codes onto each generated item. This process may also require an additional review by an independent group of SMEs to ensure that the appropriate content code is selected and that the content codes are consistently applied to items. But perhaps the most important limitation of ad hoc content coding is that the links among the data elements are both precarious and uncertain because coding proceeds ad hoc rather than a priori.

The second method is based on applying a predefined content coding nomenclature found in a taxonomy, wherein the content coding occurs before the generation of the item occurs. Various taxonomies for content are coding are known in the art, and include the science taxonomy from the National Assessment of Educational Progress (NAEP) to describe content areas and practices for K-12 students, the CANMEDS taxonomy developed by the Royal College of Physicians and Surgeons of Canada, SNOMED Clinical terms developed by SNOMED International, of ICD-11 developed and maintained by the World Health Organization.

These pre-existing taxonomy based codes have an established meaning for SMEs, educators, and psychometricians so that they can be used to describe a specific data element thereby ensuring the coded outcome is interpretable. Further, using an established taxonomy allows data elements to be linked to other types of content, both internal to and external from, the taxonomy; thereby creating sources of data about the content coded data to further enhance the meaning of the test items. Metadata, or data about data, is meaningful when one data element can be directly associated with a second data element, where the second element provides information about the first. Metadata can be used to describe the characteristics of each generating model or generated item thereby allowing the SME to differentiate AIG content. Metadata can also be used to link diverse kinds and diverse sources of information together to create new types of information that, in turn, form meaningful structures of knowledge about the content in the bank. Metadata permits the SME to organize, track, and manage large amounts of information that is a defining characteristic of AIG.

The main disadvantage of using a specific taxonomy is that it may hamper or even restrict the content coding task, as coding is limited to the content in the taxonomy. A novel AIG cognitive model could be created to produce unique items that fall outside the range of the existing content codes as described in a taxonomy resulting in items that cannot be coded and classified. To address this limitation, multiplicities of taxonomies can be used to provide content codes for the generating models and the generated items where each taxonomy contain different levels of information so that one taxonomy, for instance, can be used to describe more specific information while another taxonomy can be used to describe more general information. Using multiplicities of taxonomies provides the opportunity to classify any given data element using multiple content codings, or the item model itself by way of multiple taxonomies.

Where the art contemplates generation of items by way of AIG through a three-step process (content for item generation is identified, an item model is developed, and computer-based algorithms place the cognitive model content specified in step 1 into the item model developed in step 2), the present invention contemplates applying the content codes to models during the model creation. These content codes or metadata are then assembled across all of the content coding locations (e.g., model, variable, value, option) during item generation in step 3 to produce a unique metadata and content code list for each item generated.

Logical constraints provide a straight-forward approach for generating items when item modelling is used. The generation process permutes through all combinations of values and eliminates combinations that do not meet the constraints defined by the SME in the cognitive model; with the outcome being a set of generated items. To produce descriptive data for each generated item, the metadata or content codes that are used for each model are added together to produce a list. This list, in turn, includes all of the metadata or content codes that were used in the item model coding process. As a result, multiple metadata or content codes serve as the data that can be used to describe each generated item. Because different models, variables, values, and options contain different metadata or content codes, a unique list of metadata or content codes is compiled for each generated item.

### EXAMPLE 1

### Use of a Taxonomy for Generation of Content Coding in Item Models Using AIG

The International Classification of Diseases (ICD-11) is the eleventh revision of the World Health Organization's classification system for content coding health information which provides a common language that is used throughout the world for defining and reporting on diseases and other health-related problems. The foundational taxonomy is called the ICD-11 MMS (Mortality and Morbidity Statistics, the ICD-11), which contains more than 85,000 entities, where entities can be chapters, blocks or categories. ICD-11 consists of 28 chapters, being the top-level entity of the taxonomy; and within each chapter, a block is used to group related categories. A category is presented within a block where a category can be anything that is relevant to health care. All categories have a unique ICD code.

The ICD-11 is an example of a contemporary medical taxonomy that can be used to describe medical outcomes such as disease; hence, the ICD chapters, blocks, and categories can each be used as content codes for the model-level descriptors as well as the correct and incorrect options in an item model. In addition, the ICD-11 chapters, blocks, and categories are structured as a taxonomy and therefore have added meaning because of their position in the hierarchy as well as their relationships to one another.

SNOMED, the acronym for Systematized Nomenclature of Medicine, is an international classification system for medical terms that provides content codes needed for clinical documentation and reporting. SNOMEDS provides a common language for defining and reporting on healthcare processes. It contains more than 350,000 concepts, where a concept is an entry that describes a clinical term, with each concept having a unique ID. Concepts are organized in hierarchies. As a result, concepts can be related to one another using more than 1.3 million links within the classification system. Concepts are also described by different clinical terms and phrases called descriptions thereby providing elaborated information for each category code. SNOMED serves as an example of a contemporary medical taxonomy that can be used to describe medical inputs such as healthcare processes. Hence, the SNOMED concepts and descriptions can be used as content codes for the variables and values in an item model. The SNOMED concepts and descriptions are structured as a taxonomy that contain millions of connections that provide additional meaning to the categories and descriptions because of their position in the hierarchy as well as their relationships to one another.

Taken together, the ICD-11 and SNOMED serve as two comprehensive classification systems for describing medical outcomes and processes, respectively. Both classification systems contain an extensive list of content codes that can be used to describe the model, variables, values, options in a medical item model. Both classification systems are also structured as a hierarchy which means that the content codes can be used to describe and to link data in a medical item model.

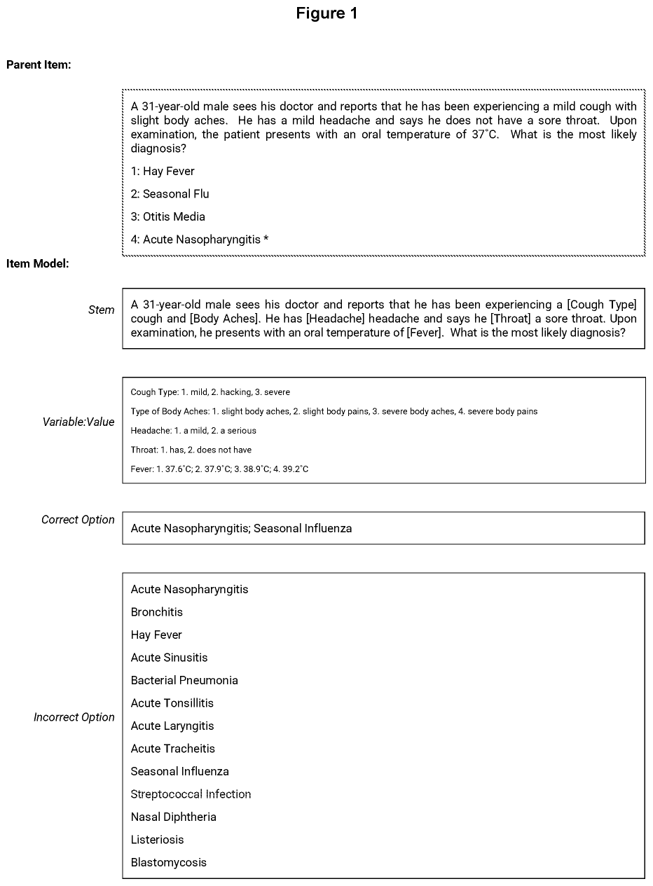

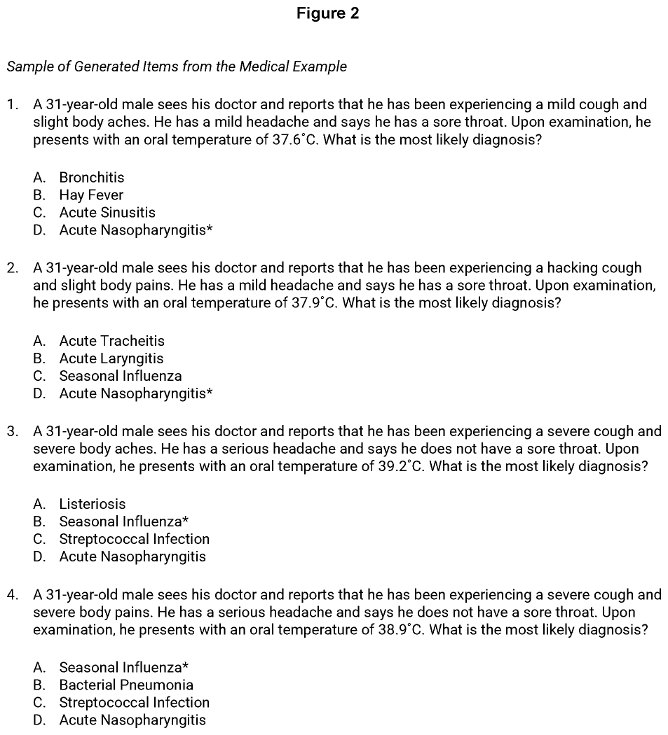

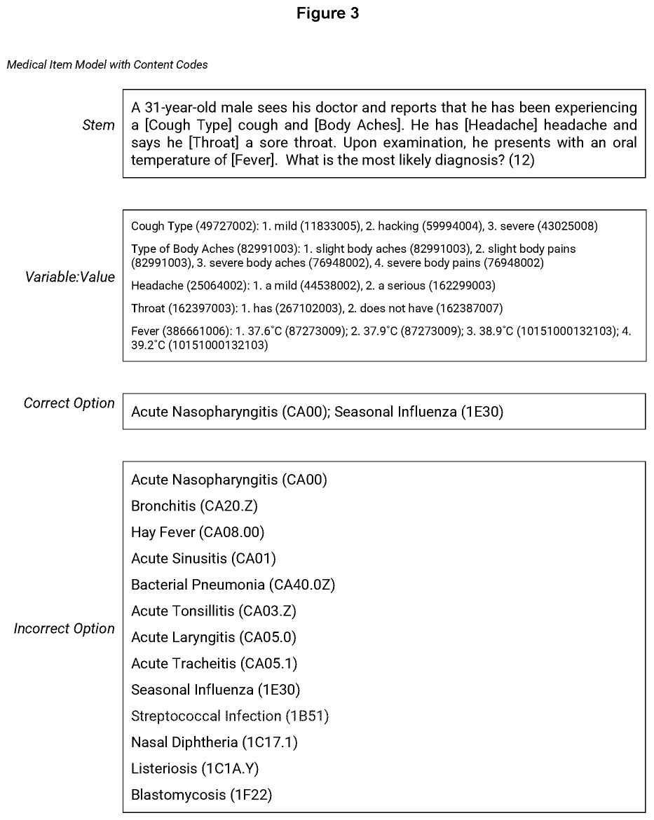

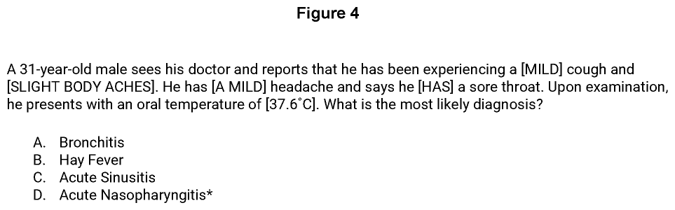

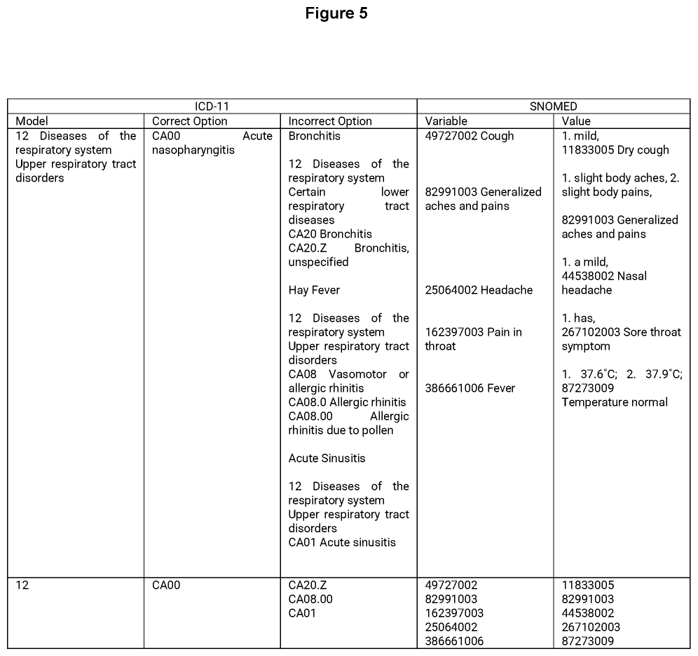

ICD-11 and SNOMED were used to content coding the item model presented in FIG. 1 with example items capable of being generated by this model presented in FIG. 2. The medical model example with content codes is presented in FIG. 3. Because content coding is conducted at the model level, a string of metadata for each item is capable of being produced during the generation process. As a result, a unique string of content codes is created for each generated item. One generated item is shown in FIG. 4, with exemplary content coding for the item presented in FIG. 4 shown in FIG. 5.

The present invention contemplates a system, implemented through a computing device, for the searching, requesting, and dispensing of computer-generated test items generated from a test model. In one non-limiting embodiment of the system, a computing device includes one or more processors or microprocessors for the implementation of electronic logic operations. The processor may include hardware in electronic communication with the processor or a or software module operating on the processor, said software module stored in an external or internal storage device configured to provide instructions to, and in turn control, the processor or microprocessor. It is contemplated that the external or internal storage device may provide a form of computer readable memory for the computer. Examples of an external storage device include a hard disk drive, a magnetic disk drive, tape drive, solid state drive, or the like. The external or internal storage drives can be used to store code for the control and operation of the processor or microprocessor, or to contain data for carrying out the disclosed techniques described herein. In particular the external or internal storage devices may provide system access to metadata databases, or content coding databases, by way of structured or unstructured storage architectures.

It is contemplated that a computing device includes a computer readable memory for the storing of information and instructions to be executed by said one or more processors or microprocessors. It is contemplated that the computer readable memory may be a random-access memory, read only memory, or dynamic memory systems as generally known in the art. A computing device may also include a graphical user interface, allowing improved interaction with the computing device and software operating thereon, by the user.

While particular embodiments of the present invention have been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiments. The invention is therefore to be considered limited solely by the scope of the appended claims.

What is claimed is:

1. A system for generating, recording and communicating test items generated from a test model comprising
a. A computing device configured to communicate with a user, the computing device comprising a processor and a graphical user interface;
b. A computer readable memory with computer executable instructions embedded thereon, the computer executable instructions configured to cause the processor to:
i. Display on said graphical user interface a model identifier correlating with those test models containing content coding selected by said user;
ii. Display on said graphical user interface a number of items that may be generated by each test model containing content coding selected by said user;
iii. Receive a request from said user to generate test items from at least one of said test model containing content coding selected by said user;
iv. Record generated test items from at least one of said test model containing content coding selected by said user;
v. Display on said graphical user interface an item identifier correlating with generated test items;
vi. Display on said graphical user interface generated test items selected for display by said user; and
vii. Communicate from the record of generated test items those generated test items selected by said user to a system of said user's choice;
Wherein test models containing metadata are data structures comprising an item generation model and at least one item of metadata associated with said item generation model.

2. The system of claim 1 wherein said system of said user's choice is a QTI compliant data exchange.

3. The system of claim 1 wherein the data structure further comprises at least one variable within said item model having an item of content coding associated with said item model.

4. The system of claim 3 wherein said request from said user to generate test items from at least one of said test model containing content coding includes constraints on the test items to be generated selected from the group comprising additional content coding values, a maximum number of test items to be generated, and communication instructions for said generated test items.

5. The system of claim 4 wherein the data structure further comprises a list of all previously generated items from the item generation model.

6. (canceled)
